(19) United States
(12) Patent Application Publication
(10) Pub. No.: US 2021/0107486 A1
(43) Pub. Date: Apr. 15, 2021

(54) APPARATUS FOR DETERMINING LANE CHANGE STRATEGY OF AUTONOMOUS VEHICLE AND METHOD THEREOF

(71) Applicants: HYUNDAI MOTOR COMPANY, Seoul (KR); KIA MOTORS CORPORATION, Seoul (KR)

(72) Inventor: Tae Dong OH, Suwonsi (KR)

(73) Assignees: HYUNDAI MOTOR COMPANY, Seoul (KR); KIA MOTORS CORPORATION, Seoul (KR)

(21) Appl. No.: 16/839,884

(22) Filed: Apr. 3, 2020

(30) Foreign Application Priority Data
Oct. 15, 2019 (KR) 10-2019-0128052

(51) Int. Cl. B60W 30/18; B60W 60/00

(52) U.S. Cl. CPC B60W 30/18163; B60W 60/00274; B60W 60/0011

(57) ABSTRACT

An apparatus for determining a lane change strategy of an autonomous vehicle includes: a learning device that classifies situation information into a plurality of groups and learns a lane change strategy for each situation corresponding to respective groups of the plurality of groups when an autonomous vehicle changes lanes; and a controller that periodically determines a lane change strategy suitable for a current situation based on the learned lane change strategy for each situation.

### CROSS-REFERENCE TO RELATED APPLICATION

This application claims priority to and the benefit of Korean Patent Application No. 10-2019-0128052, filed on Oct. 15, 2019, the entire contents of which are incorporated herein by reference.

### FIELD

The present disclosure relates to a technology of determining lane change strategy of an autonomous vehicle based on deep learning.

### BACKGROUND

The statements in this section merely provide background information related to the present disclosure and may not constitute prior art.

In general, a deep learning (or a deep neural network), which is a kind of machine learning, includes an artificial neural network (ANN) of several layers between an input and an output. Such an artificial neural network may include a convolutional neural network (CNN) or a recurrent neural network (RNN) corresponding to a structure, a problem and an object to be solved.

The deep learning is used to solve various problems such as classification, regression, localization, detection, segmentation, and the like. In particular, in an autonomous system, semantic segmentation and object detection, which can determine the location and type of a dynamic and static obstacle, are important.

The semantic segmentation means performing segmentation prediction in units of pixels to search for an object in an image, and segmenting in units of pixels having the same meaning. Thus, it is possible not only to identify what objects are in the image, but also to pinpoint the location of pixels that have the same meaning (the same object).

Object detection means classifying and predicting the type of an object in an image and searching for the location information of the object through regression prediction of a bounding box. Thus, unlike the simple classification, it is possible to grasp not only the type of the object in the image but also the location information of the object.

There have not been proposed any techniques for determining a lane change strategy of an autonomous vehicle based on such deep learning.

### SUMMARY

The present disclosure has been made to solve the above-mentioned problems occurring in the prior art while advantages achieved by the prior art are maintained intact.

An aspect of the present disclosure provides an apparatus for determining a lane change strategy of an autonomous vehicle and a method thereof which can perform deep learning by subdividing various situation information to be considered for safety at the time of lane change of autonomous vehicle by group, and based on the learned result, determine the lane change strategy of autonomous vehicle, thereby generating an optimal driving route in the lane change process of the autonomous vehicle.

The technical problems to be solved by the present inventive concept are not limited to the aforementioned problems, and any other technical problems not mentioned herein will be clearly understood from the following description by those skilled in the art to which the present disclosure pertains.

According to an aspect of the present disclosure, an apparatus for determining a lane change strategy of an autonomous vehicle includes: a learning device that classifies situation information into a plurality of groups and learns a lane change strategy for each situation corresponding to respective groups of the plurality of groups when an autonomous vehicle changes lanes, and a controller that periodically determines a lane change strategy suitable for a current situation based on the learned lane change strategy for each situation.

The apparatus may further include storage that stores a plurality of lane change strategies for each situation.

The plurality of lane change strategies may be matched with a score corresponding to a learning result by the learning device.

The plurality of lane change strategies may include: a strategy for changing lanes normally, a strategy for returning to a current lane in a state where the autonomous vehicle does not enter a target lane during lane change, and a strategy for returning to the current lane in a state where the autonomous vehicle enters the target lane during lane change.

The controller may determine, among the plurality of lane change strategies, a lane change strategy having a highest score corresponding to the current situation, as the lane change strategy of the autonomous vehicle.

The controller may adjust a score of each lane change strategy corresponding to the current situation based on a risk obtained in a lane change process of the autonomous vehicle. In this case, the risk may include a number of collision warnings.

The apparatus may further include an input device that inputs data of situation information at a present time point to a corresponding group among the plurality of groups.

The input device may include at least one of a first data extractor configured to extract first group data for preventing a collision with a nearby vehicle when the autonomous vehicle changes lanes, a second data extractor configured to extract, as second group data, lighting states of various traffic lights located in front of the autonomous vehicle when the autonomous vehicle changes lanes, a third data extractor configured to extract drivable areas corresponding to a distribution of a static object, a construction section and an accident section as third group data, a fourth data extractor configured to extract a drivable area corresponding to a road structure as fourth group data, or a fifth data extractor configured to extract, as fifth group data, an overlapping area between the drivable areas extracted by the third and fourth data extractors.

According to another aspect of the present disclosure, a method of determining a lane change strategy of an autonomous vehicle includes: classifying, by a learning device, situation information into a plurality of situation groups; learning, by the learning device, a lane change strategy for each situation of the plurality of situation group when an autonomous vehicle changes lanes; and periodically determining, by a controller, a lane change strategy suitable for a current situation based on the learned lane change strategy by the learning device.

The method may further include storing, by a storage, a plurality of lane change strategies for each situation.

The plurality of lane change strategies may be matched with a score corresponding to a learning result by the learning device.

The plurality of lane change strategies may include: a strategy for changing lanes normally, a strategy for returning to a current lane in a state where the autonomous vehicle does not enter a target lane during lane change, and a strategy for returning to the current lane in a state where the autonomous vehicle enters the target lane during lane change.

The periodic determining of the lane change strategy may include determining, among the plurality of lane change strategies, a lane change strategy having a highest score corresponding to the current situation, as the lane change strategy of the autonomous vehicle.

The method may further include adjusting, by the controller, a score of each lane change strategy corresponding to the current situation based on a risk obtained in a lane change process of the autonomous vehicle. In this case, the risk includes a number of collision warnings.

The method may further include inputting, by an input device, data of situation information at a present time point to a corresponding situation group among the plurality of situation groups.

In one form, inputting the data to each situation group of the plurality of situation groups may include: extracting first group data for preventing a collision with a nearby vehicle when the autonomous vehicle changes lanes; extracting, as second group data, lighting states of various traffic lights located in front of the autonomous vehicle when the autonomous vehicle changes lanes; extracting drivable areas corresponding to a distribution of a static object, a construction section and an accident section as third group data; extracting a drivable area corresponding to a road structure as fourth group data; and extracting, as fifth group data, an overlapping area between the drivable areas extracted by the third and fourth data extractors.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 is a block diagram illustrating a lane change strategy determination apparatus of an autonomous vehicle;

FIGS. 2A to 2C are exemplary diagrams illustrating a lane change strategy for each situation learned by the apparatus for determining a lane change strategy of an autonomous vehicle;

FIG. 3 is a view illustrating a detailed configuration of a lane change strategy determination apparatus of an autonomous vehicle;

FIGS. 4A to 4C are views illustrating a situation in which the first data extractor included in a lane change strategy determination apparatus of an autonomous vehicle extracts the first group data;

FIG. 5 is a view illustrating a situation in which the second data extractor provided in the lane change strategy determination apparatus of the autonomous vehicle extracts the second group data;

FIGS. 6A and 6B are views illustrating a situation in which the third data extractor provided in the lane change strategy determination apparatus of an autonomous vehicle extracts the third group data;

FIGS. 7A and 7B are views illustrating a situation in which the fourth data extractor provided in the lane change strategy determination apparatus of the autonomous vehicle extracts the fourth group data;

FIG. 8 is a view illustrating a final lane changeable area extracted by a fifth data extractor included in a lane change strategy determination apparatus of an autonomous vehicle as the fifth group data;

FIG. 9 is a view illustrating a process of determining the risk of the risk determination device provided in a lane change strategy determination apparatus of an autonomous vehicle;

FIG. 10 is a flowchart illustrating a lane change strategy determination method of an autonomous vehicle; and

FIG. 11 is a block diagram illustrating a computing system for executing a lane change strategy determination method of an autonomous vehicle.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

Hereinafter, some forms of the present disclosure will be described in detail with reference to the exemplary drawings. In adding the reference numerals to the components of each drawing, it should be noted that the identical or equivalent component is designated by the identical numeral even when they are displayed on other drawings. Further, in describing the exemplary forms of the present disclosure, a detailed description of well-known features or functions will be ruled out in order not to unnecessarily obscure the gist of the present disclosure.

In describing the components of the form according to the present disclosure, terms such as first, second, “A”, “B”, (a), (b), and the like may be used. These terms are merely intended to distinguish one component from another component, and the terms do not limit the nature, sequence or order of the constituent components. Unless otherwise defined, all terms used herein, including technical or scientific terms, have the same meanings as those generally understood by those skilled in the art to which the present disclosure pertains. Such terms as those defined in a generally used dictionary are to be interpreted as having meanings equal to the contextual meanings in the relevant field of art, and are not to be interpreted as having ideal or excessively formal meanings unless clearly defined as having such in the present application.

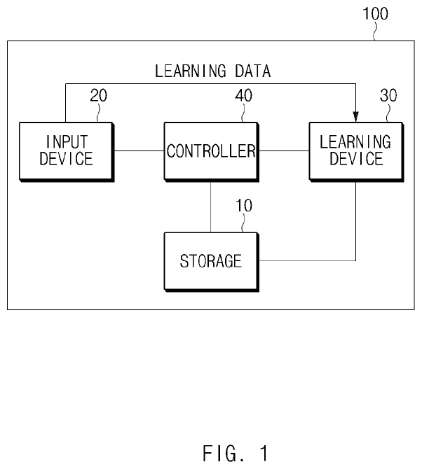

FIG. 1 is a block diagram illustrating a lane change strategy determination apparatus of an autonomous vehicle according to one form of the present disclosure.

As shown in FIG. 1, a lane change strategy determination apparatus 100 of an autonomous vehicle according to one form of the present disclosure may include storage 10, an input device 20, a learning device 30, and a controller 40. In this case, according to a scheme of implementing the lane change strategy determination apparatus 100 of an autonomous vehicle according to one form of the present disclosure, components may be combined with each other and implemented as one, or some components may be omitted. In particular, the learning device 30 may be implemented to be included in the controller 40 as one function block of the controller 40.

Looking at the respective components, first, the storage 10 may include various logics, algorithms, and programs required in the operations of performing deep learning by subdividing various situation information to be considered for safety at the time of a lane change of an autonomous vehicle by group and determining the lane change strategy of the autonomous vehicle based on the learning result.

The storage 10 may store, for example, a lane change strategy model for each situation as the learning result of the learning device 30.

The storage 10 may store a plurality of lane change strategies for each situation. In this case, each lane change strategy may have a score corresponding to the learning result, where the score represents the possibility of being selected as the lane change strategy.

For example, in a specific situation, when the score of a first lane change strategy is 80%, the score of a second lane change strategy is 10%, the score of a third lane change strategy is 5%, the score of a fourth lane change strategy is 3%, and the score of a fifth lane change strategy is 2%, as the lane change strategy in the specific situation, the first lane change strategy having the highest score may be determined.

The storage 10 may include at least one type of a storage medium of memories of a flash memory type, a hard disk type, a micro type, a card type (e.g., a secure digital (SD) card or an extreme digital (XD) card), and the like, and a random access memory (RAM), a static RAM, a read-only memory (ROM), a programmable ROM (PROM), an electrically erasable PROM (EEPROM), a magnetic memory (MRAM), a magnetic disk, and an optical disk type memory.

Next, the input device 20 may input (provide), to the learning device 30, the data (learning data) required in the operation of learning a lane change strategy desired for each situation.

In addition, the input device 20 may perform a function of inputting, to the controller 40, data of the current time point required in the process of determining the lane change strategy of the autonomous vehicle.

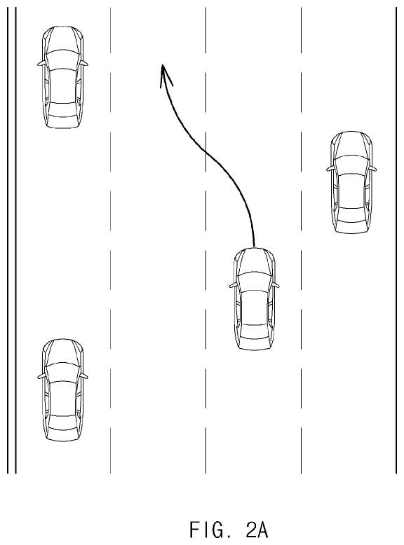

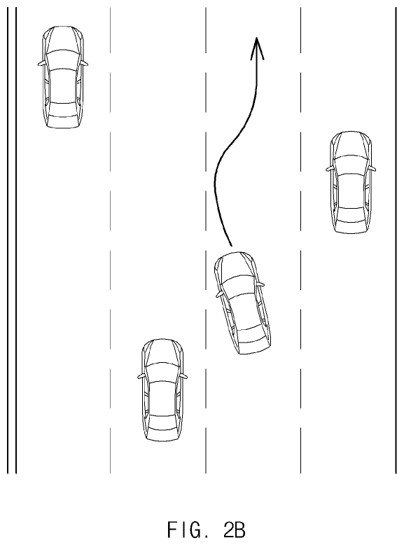

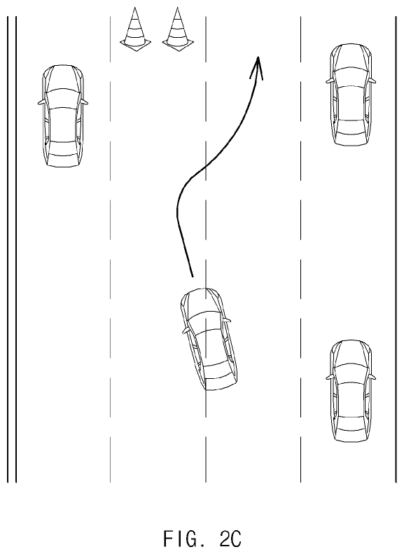

Next, the learning device 30 learns the learning data input through the input device 20 based on deep learning. In this case, the learning data has a form in which various situation information to be considered for safety at the time of the lane change of the autonomous vehicle is subdivided by group. That is, the learning device 30 learns the optimal lane change strategies for each situation. In this case, for example, the lane change strategy is shown in FIGS. 2A to 2C.

FIGS. 2A to 2C are exemplary diagrams illustrating a lane change strategy for each situation learned by the apparatus for determining a lane change strategy of an autonomous vehicle according to one form of the present disclosure.

FIG. 2A illustrates a normal lane change as the first lane change strategy according to one form of the present disclosure. FIG. 2B illustrates the return to a current lane during lane change as the second lane change strategy according to one form of the present disclosure. FIG. 2C illustrates the return from a target lane during lane change as a third lane change strategy according to one form of the present disclosure. That is, FIG. 2B refers to a strategy by which the autonomous vehicle travels continuously on the current lane in a state where the autonomous vehicle does not enter the target lane in a lane change process. FIG. 2C illustrates a strategy by which the autonomous vehicle returns to the current lane in a state where the autonomous vehicle enters the target lane in a lane change process. For reference, because the autonomous vehicle determines a new lane change strategy for a current situation even while changing lanes, as shown in FIG. 2A, the autonomous vehicle may normally change lanes corresponding to the return strategy in the current lane or the return strategy from the target lane without returning to the current lane.

In this case, the normal lane change may include various lane change cases such as lane change to the front of the vehicle traveling in the target lane, lane change corresponding to the spaced distance from a vehicle traveling in the target lane, lane change to the rear of a vehicle traveling in the target lane, and the like.

In one foam of the present disclosure, as an example, three lane change strategies has been described, but the number of lane change strategies may vary depending on the intention of the designer and it does not affect the present disclosure.

Meanwhile, the learning device 30 may perform learning in various ways. For example, the learning device may perform simulation-based learning in the early stage of no learning at all, learning based on cloud server (not shown) in the middle in which learning is conducted to some extent, and additional learning based on the lane change propensity of an individual after the learning is completed. In this case, the cloud server collects various situation information from a plurality of vehicles performing lane change and infrastructure, and provides the collected situation information to autonomous vehicles as learning data.

Next, the controller 40 performs the overall control such that each component can perform its function. The controller 40 may be implemented in the form of hardware or software, or may be implemented in the form of a combination of hardware and software. In one form, the controller 40 may be implemented with a microprocessor, but is not limited thereto.

In particular, the controller 40 may perform deep learning by subdividing the various situation information to be considered for safety at the time of the lane change of the autonomous vehicle by group, and perform various controls required in the operation of determining a lane change strategy of an autonomous vehicle based on the learning result.

The controller 40 may determine the lane change strategy of the autonomous vehicle by applying data on the surrounding situation at the current time point input through the input device 20 to the learning result of the learning device 30

The controller 40 may adjust the score of each lane change strategy for each situation stored in the storage 10 based on the risk (e.g., the number of collision warnings) obtained in the lane change process of the autonomous vehicle.

For example, in a specific situation, when the score of the first lane change strategy is 80%, the score of the second lane change strategy is 10%, the score of the third lane change strategy is 5%, the score of the fourth lane change strategy is 3%, and the score for the fifth lane change strategy is 2%, the score of the first lane change strategy may be reduced from 80% to 70% and the score of the second lane change strategy may be increased from 10% to 20% corresponding to the number of risks incurred during lane change based on the first lane change strategy. When the risk occurs frequently when the first lane change strategy is applied in the specific situation, the score of the second lane change strategy may be greater than that of the first lane change strategy.

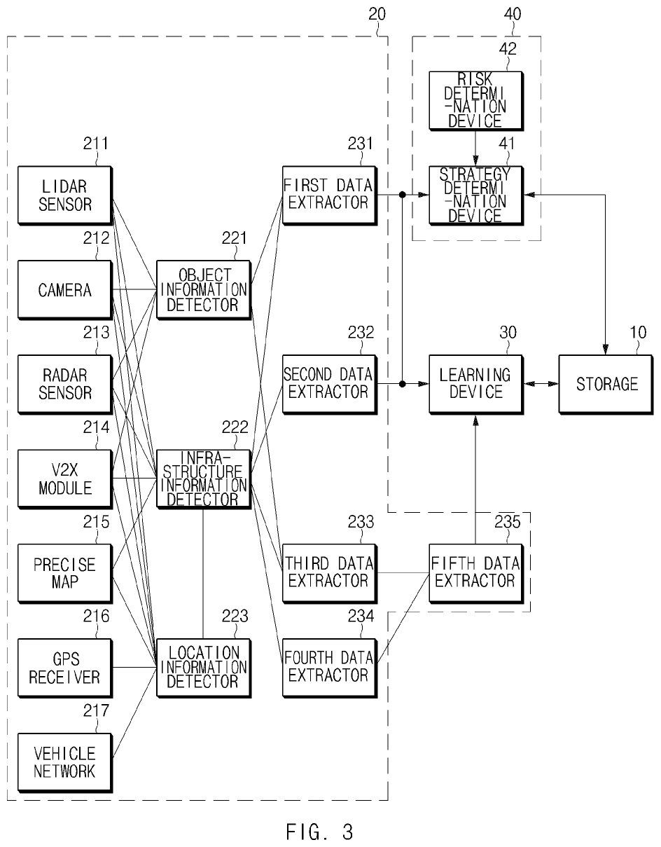

FIG. 3 is a detailed configuration diagram of a lane change strategy determination apparatus of an autonomous vehicle according to one form of the present disclosure.

As shown in FIG. 3, the input device 20 may include a light detection and ranging (LiDAR) sensor 211, a camera 212, a radio detecting and ranging (Radar) sensor 213, a V2X module 214, a precise map 215, a global positioning system (GPS) receiver 216, and a vehicle network 217.

The LiDAR sensor 211, which is a kind of environmental awareness sensor, is mounted on the autonomous vehicle and measures the location coordinates and the like of a reflector based on the time taken to return thereto after shooting a laser beam in all directions while being rotated.

The camera 212 is mounted to the rear of an interior room mirror of the autonomous vehicle to take an image including a lane, a vehicle, a person and the like located around the autonomous vehicle.

The radar sensor 213 receives the electromagnetic wave reflected from an object after shooting an electromagnetic wave to measure the distance to the object, the direction of the object, and the like. The radar sensor 213 may be mounted on the front bumper and the rear side of the autonomous vehicle, recognize a long distance object, and be hardly affected by weather.

The V2X module 214 may include a vehicle-to-vehicle (V2V) module and a vehicle-to-infrastructure (V2I) module. The V2V module may communicate with a nearby vehicle to obtain the location, speed, acceleration, yaw rate, traveling direction, and the like of another nearby vehicle. The V2I module may obtain information about the shape of a road, surrounding structures, traffic lights (e.g., a location, and a lighting state (red, yellow, green, and the like)), and the like from an infrastructure.

The precise map 215, which is a map for autonomous driving, may include information about lanes, traffic lights, signs, and the like for accurate location measurement of the autonomous vehicle and safety enhancement of autonomous driving.

The GPS receiver 216 receives GPS signals from three or more GPS satellites.

The vehicle network 217, which is a network for communication between controllers in an autonomous vehicle, may include a controller area network (CAN), a local interconnect network (LIN), a FlexRay, a media oriented systems transport (MOST), an Ethernet, and the like.

In addition, the input device 20 may include an object information detector 221, an infrastructure information detector 222, and a location information detector 223.

The object information detector 221 detects object information around the autonomous vehicle based on the Lidar sensor 211, the camera 212, the radar sensor 213, and the V2X module 214. In this case, the object may include a vehicle, a person, and an object located on a road, and the object information may include a speed, an acceleration, a yaw rate, yaw rate, a cumulative value of longitudinal acceleration over time, and the like as information about an object.

The infrastructure information detector 222 detects the infrastructure information around the autonomous vehicle based on the Lidar sensor 211, the camera 212, the radar sensor 213, the V2X module 214, and the precise map 215. In this case, the infrastructure information includes a shape of a road (lanes, a central divider, and the like), a surrounding structure, a traffic light state, a crosswalk outline, a road boundary, and the like.

The location information detector 223 detects the location information of the autonomous vehicle based on the Lidar sensor 211, the camera 212, the radar sensor 213, the V2X module 214, the precise map 215, the GPS receiver 216, and the vehicle network 217. In this case, the location information may include reliability information indicating the accuracy of the location information detection.

In addition, the input device 20 may include a first data extractor 231, a second data extractor 232, a third data extractor 233, a fourth data extractor 234, and a fifth data extractor 235.

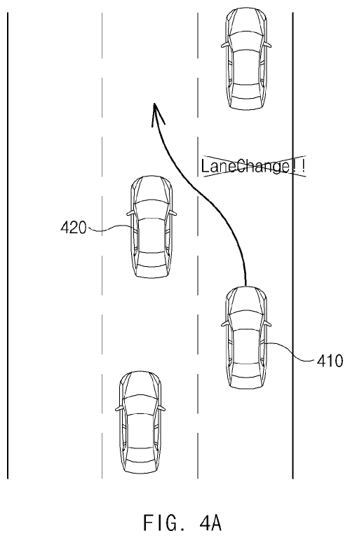

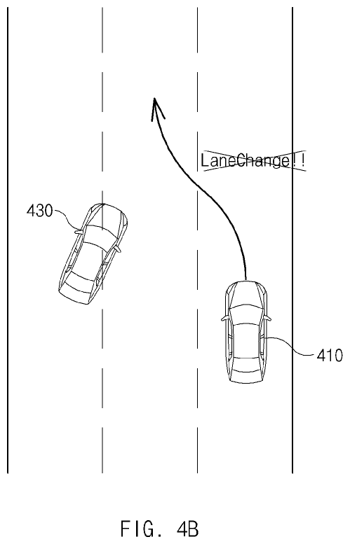

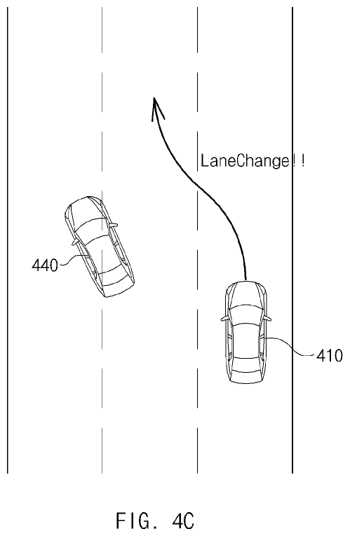

Hereinafter, a process of subdividing various situation information to be considered for safety at the time of a lane change of an autonomous vehicle by group will be described with reference to FIGS. 4 to 9.

FIGS. 4A to 4C are views illustrating a situation in which the first data extractor included in a lane change strategy determination apparatus of an autonomous vehicle according to one form of the present disclosure extracts the first group data.

As shown in FIGS. 4A to 4C, the first data extractor 231 may extract the first group data for preventing a collision with surrounding vehicles 420, 430 and 440 at the time of the lane change of an autonomous vehicle 410 from the object information and the infrastructure information. In this case, the first group data may include the locations, speeds, accelerations, yaw rates, traveling directions, and the like of the surrounding vehicles 420, 430 and 440.

FIG. 4A illustrates a case in which a collision with the surrounding vehicle 420 driving on a target lane occurs when the autonomous vehicle 410 changes lanes. FIG. 4B illustrates a case in which a collision with the surrounding vehicle 430 entering the target lane occurs when the autonomous vehicle 410 changes lanes. FIG. 4C illustrates a case in which a drastic lane change is possible due to the departure of the surrounding vehicle 440 from the target lane when the autonomous vehicle 410 changes lanes.

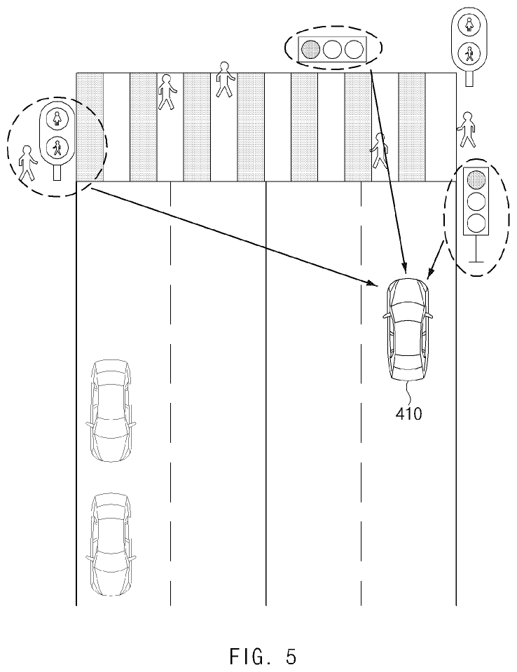

FIG. 5 is a view illustrating a situation in which the second data extractor provided in the lane change strategy determination apparatus of the autonomous vehicle according to one form of the present disclosure extracts the second group data.

As shown in FIG. 5, the second data extractor 232 obtains a lighting state of each traffic light located around the autonomous vehicle 410 based on the infrastructure information, and extracts, as the second group data, the lighting state of the traffic light related to the lane change of the autonomous vehicle 410 from the obtained lighting states of traffic lights. In this case, the traffic light may include a vehicle traffic light and a pedestrian traffic light associated with the lane change of the autonomous vehicle 410 at an intersection.

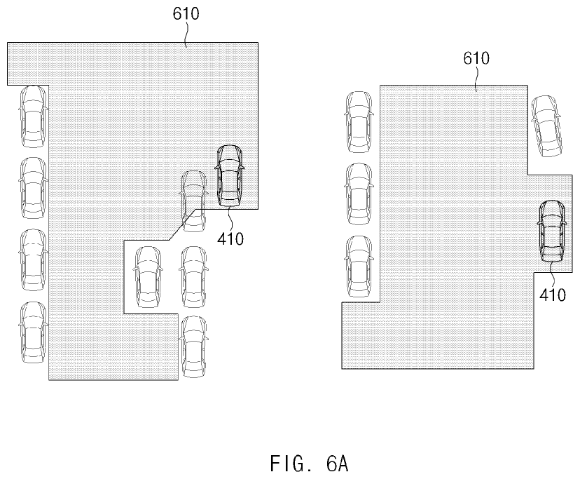

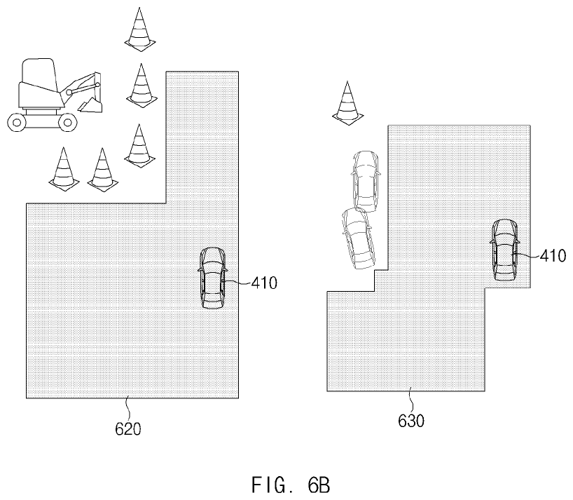

FIGS. 6A and 6B are views illustrating a situation in which the third data extractor provided in the lane change strategy determination apparatus of an autonomous vehicle according to one form of the present disclosure extracts the third group data.

As shown in FIG. 6A, the third data extractor 233 may extract, as the third group data, a lane changeable area 610 corresponding to the distribution of static objects (e.g., parked vehicles) based on the object information and the infrastructure information.

As shown in FIG. 6B, the third data extractor 233 may further extract, as the third group data, a lane changeable area 620 corresponding a construction section and a lane changeable area 630 corresponding to an accident section based on the object information and the infrastructure information.

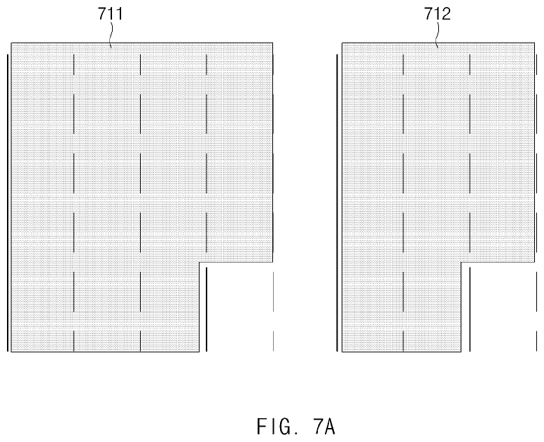

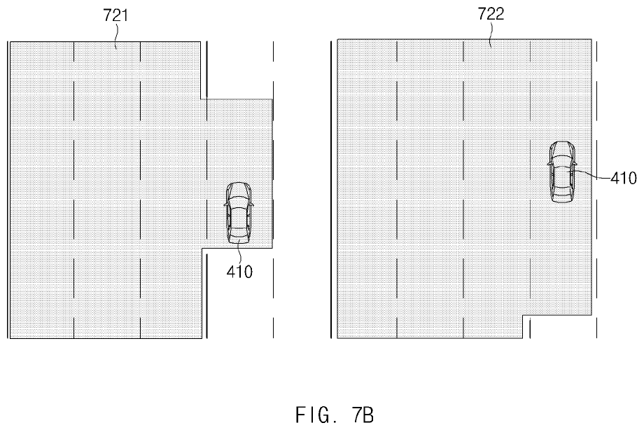

FIGS. 7A and 7B are views illustrating a situation in which the fourth data extractor provided in the lane change strategy determination apparatus of the autonomous vehicle according to one form of the present disclosure extracts the fourth group data.

The fourth data extractor 234 may extract a lane changeable area corresponding to the structure of a road based on the infrastructure information as the fourth group data.

As shown in FIG. 7A, the fourth data extractor 234 may extract lane changeable areas 711 and 712 from an image photographed by the camera 212.

As shown in FIG. 7B, the fourth data extractor 234 may extract the lane changeable areas 721 and 722 based on the location of the autonomous vehicle 410 on the precise map 215.

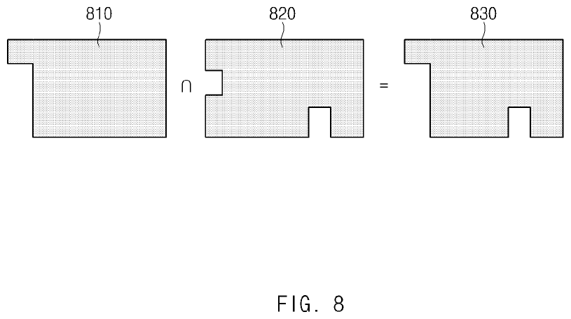

FIG. 8 is a view illustrating a final lane changeable area extracted by a fifth data extractor included in a lane change strategy determination apparatus of an autonomous vehicle according to one form of the present disclosure as the fifth group data.

As shown in FIG. 8, the fifth data extractor 235 may extract an overlap area (a final lane changeable area) 830 between a lane changeable area 810 extracted by the third data extractor 233 and a lane changeable area 820 extracted by the fourth data extractor 234 as the fifth group data.

Meanwhile, the learning device 30 learns the lane change strategies for each situation by using data extracted by the first, second and fifth data extractors 231, 232 and 235 based on the deep learning. The learning result of the learning device 30 may be used for the strategy determination device 41 to determine the lane change strategy of the autonomous vehicle.

The learning device 30 may further learn by receiving avoiding lane information when an abnormal situation (construction, accident, rock fall, pedestrian) occurs in front of the driving lane of the autonomous vehicle.

The learning device 30 may use at least one of artificial neural networks such as a convolutional neural network (CNN), a recurrent neural network (RNN), a restricted Boltzmann machine (RBM), a deep belief network (DBN), a deep Q-network, a generative adversarial network (GAN), and a softmax. In this case, at least 10 hidden layers of the artificial neural network, and 500 or more hidden nodes in the hidden layer are desired, but are not limited thereto.

The controller 40 may include the strategy determination device 41 and a risk determination device 42 which are functional blocks.

The strategy determination device 41 may determine the lane change strategy of the autonomous vehicle by applying the data extracted by the first, second and fifth data extractors 231, 232 and 235 to the learning result of the learning device 30.

The strategy determination device 41 may adjust the scores of the lane change strategies for each situation stored in the storage 10, based on the risk level (e.g., the number of collision warnings) determined by the risk determination device 42 in the process of changing lanes corresponding to the determined lane change strategy.

The risk determination device 42 may determine the risk in various schemes such as a time to collision (TTC), a driving prediction route, a grid map, and the like.

For example, when determining the risk based on the TTC, the risk determination device 42 may determine the risk by counting the number of times (the number of warnings) that the TTC is less than or equal to a threshold. For example, when a warning occurs even once, it may be determined that there is a risk, and as the number of warnings increases, the risk may be determined to be greater.

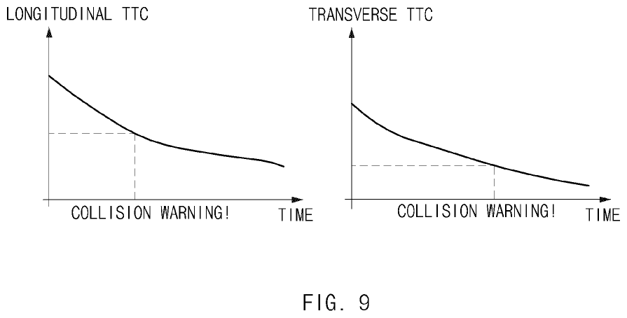

When the risk determination device 42 determines the risk based on the TTC, it is desired to determine the risk in consideration of a longitudinal TTC as well as a transverse TTC as shown in FIG. 9.

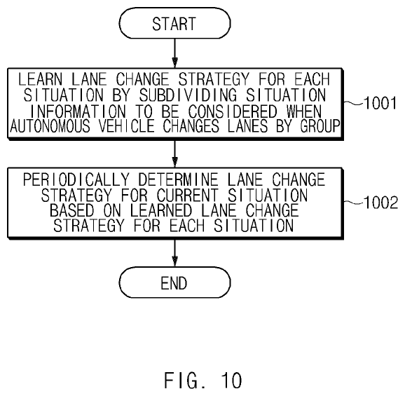

FIG. 10 is a flowchart illustrating a lane change strategy determination method of an autonomous vehicle according to one form of the present disclosure.

First, in operation 1001, the learning device 30 learns the lane change strategy for each situation by subdividing the situation information to be considered in the lane change of the autonomous vehicle by group.

Thereafter, the controller 40 periodically determines a lane change strategy for a current situation based on the lane change strategies for each situation learned by the learning device 30.

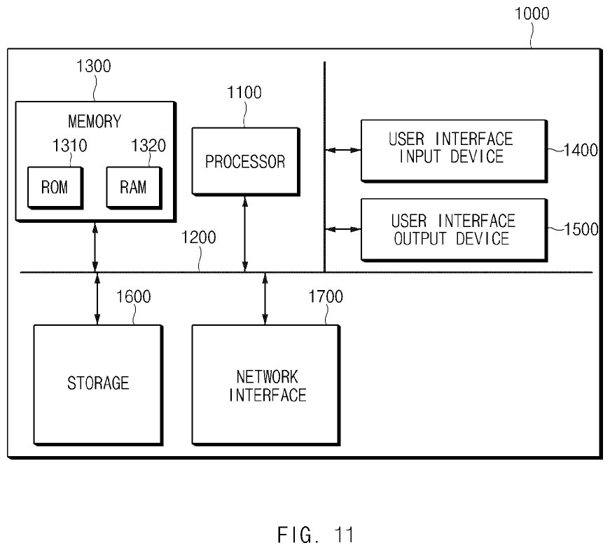

FIG. 11 is a block diagram illustrating a computing system for executing a lane change strategy determination method of an autonomous vehicle according to one form of the present disclosure.

Referring to FIG. 11, as described above, the lane change strategy determination method of an autonomous vehicle according to one form of the present disclosure may be implemented through a computing system. The computing system 1000 may include at least one processor 1100, a memory 1300, a user interface input device 1400, a user interface output device 1500, storage 1600, and a network interface 1700 connected through a system bus 1200.

The processor 1100 may be a central processing unit (CPU), or a semiconductor device that processes instructions stored in the memory 1300 and/or the storage 1600. The memory 1300 and the storage 1600 may include various types of volatile or non-volatile storage media. For example, the memory 1300 may include a read only memory (ROM) and a random access memory (RAM).

Accordingly, the processes of the method or algorithm described in relation to the forms of the present disclosure may be implemented directly by hardware executed by the processor 1100, a software module, or a combination thereof. The software module may reside in a storage medium (that is, the memory 1300 and/or the storage 1600), such as a RAM, a flash memory, a ROM, an EPROM, an EEPROM, a register, a hard disk, solid state drive (SSD), a detachable disk, or a CD-ROM. The exemplary storage medium is coupled to the processor 1100, and the processor 1100 may read information from the storage medium and may write information in the storage medium. In another method, the storage medium may be integrated with the processor 1100. The processor and the storage medium may reside in an application specific integrated circuit (ASIC). The ASIC may reside in a user terminal. In another method, the processor and the storage medium may reside in the user terminal as an individual component.

According to one form of the present disclosure, the apparatus for determining a lane change strategy of an autonomous vehicle and the method thereof may perform deep learning by subdividing various situation information to be considered for safety at the time of lane change of autonomous vehicle by group, and based on the learned result, determine the lane change strategy of autonomous vehicle. Accordingly, it is possible to generate an optimal driving route and reduce accidents which can occur in a lane change process of the autonomous vehicle.

The above description is a simple exemplification of the technical spirit of the present disclosure, and the present disclosure may be variously corrected and modified by those skilled in the art to which the present disclosure pertains without departing from the essential features of the present disclosure.

Therefore, the disclosed forms of the present disclosure do not limit the technical spirit of the present disclosure but are illustrative, and the scope of the technical spirit of the present disclosure is not limited by the forms of the present disclosure. The scope of the present disclosure should be construed by the claims, and it will be understood that all the technical spirits within the equivalent range fall within the scope of the present disclosure.

What is claimed is:

1. An apparatus for determining a lane change strategy of an autonomous vehicle, the apparatus comprising:
a learning device configured to classify situation information into a plurality of groups and learn a lane change strategy for each situation corresponding to respective groups of the plurality of groups when an autonomous vehicle changes lanes; and
a controller configured to periodically determine a lane change strategy suitable for a current situation based on the learned lane change strategy for each situation.

2. The apparatus of claim 1, further comprising:
storage configured to store a plurality of lane change strategies for each situation.

3. The apparatus of claim 2, wherein the plurality of lane change strategies are matched with a score corresponding to a learning result by the learning device.

4. The apparatus of claim 3, wherein the controller is configured to determine, among the plurality of lane change strategies, a lane change strategy having a highest score corresponding to the current situation, as the lane change strategy of the autonomous vehicle.

5. The apparatus of claim 3, wherein the controller is configured to adjust a score of each lane change strategy corresponding to the current situation based on a risk obtained in a lane change process of the autonomous vehicle.

6. The apparatus of claim 5, wherein the risk includes a number of collision warnings.

7. The apparatus of claim 2, wherein the plurality of lane change strategies includes: a strategy for changing lanes normally, a strategy for returning to a current lane in a state where the autonomous vehicle does not enter a target lane during lane change, and a strategy for returning to the current lane in a state where the autonomous vehicle enters the target lane during the lane change.

8. The apparatus of claim 1, further comprising:
an input device configured to input data of situation information at a present time point to a corresponding group among the plurality of groups.

9. The apparatus of claim 8, wherein the input device includes at least one of a first data extractor configured to extract first group data for preventing a collision with a nearby vehicle when the autonomous vehicle changes lanes, a second data extractor configured to extract, as second group data, lighting states of various traffic lights located in front of the autonomous vehicle when the autonomous vehicle changes lanes, a third data extractor configured to extract drivable areas corresponding to a distribution of a static object, a construction section and an accident section as third group data, a fourth data extractor configured to extract a drivable area corresponding to a road structure as fourth group data, or a fifth data extractor configured to extract, as fifth group data, an overlapping area between the drivable areas extracted by the third and fourth data extractors.

10. A method of determining a lane change strategy of an autonomous vehicle, the method comprising:
classifying, by a learning device, situation information into a plurality of situation groups;
learning, by the learning device, a lane change strategy for each situation of the plurality of situation groups when an autonomous vehicle changes lanes; and
periodically determining, by a controller, a lane change strategy suitable for a current situation based on the learned lane change strategy by the learning device.

11. The method of claim 10, further comprising:
storing, by a storage, a plurality of lane change strategies for each situation.

12. The method of claim 11, wherein the plurality of lane change strategies are matched with a score corresponding to a learning result by the learning device.

13. The method of claim 12, wherein periodically determining the lane change strategy includes:
determining, among the plurality of lane change strategies, a lane change strategy having a highest score corresponding to the current situation, as the lane change strategy of the autonomous vehicle.

14. The method of claim 12, further comprising:
adjusting, by the controller, a score of each lane change strategy corresponding to the current situation based on a risk obtained in a lane change process of the autonomous vehicle.

15. The method of claim 14, wherein the risk includes a number of collision warnings.

16. The method of claim 11, wherein the plurality of lane change strategies include: a strategy for changing lanes normally, a strategy for returning to a current lane in a state where the autonomous vehicle does not enter a target lane during lane change, and a strategy for returning to the current lane in a state where the autonomous vehicle enters the target lane during the lane change.

17. The method of claim 10, further comprising:
inputting, by an input device, data of situation information at a present time point to a corresponding situation group among the plurality of situation groups.

18. The method of claim 17, wherein inputting the data to each situation group of the plurality of situation groups includes:
extracting first group data for preventing a collision with a nearby vehicle when the autonomous vehicle changes lanes;
extracting, as second group data, lighting states of various traffic lights located in front of the autonomous vehicle when the autonomous vehicle changes lanes;
extracting drivable areas corresponding to a distribution of a static object, a construction section and an accident section as third group data;
extracting a drivable area corresponding to a road structure as fourth group data; and
extracting, as fifth group data, an overlapping area between the drivable areas extracted by the third and fourth data extractors.
